(19) United States
(12) Patent Application Publication
(10) Pub. No.: US 2004/0057339 A1
(43) Pub. Date: Mar. 25, 2004

(54) Wrist watch including lighting means

(76) Inventor: Marco Menini, Vogera (Pavia) (IT)

Correspondence Address: James V. Costigan, Esq., Hedman & Costigan, P.C., Suite 2003, 1185 Avenue of the Americas, New York, NY, 10036-2646, US

(21) Appl. No.: 10/254,136

(22) Filed: Sep. 25, 2002

(51) Int. Cl. G04B 47/00

(52) U.S. Cl. 368/10

(57) ABSTRACT

The present invention relates to a wrist watch including lighting means, comprising a watch casing holding the watch controlling mechanism.

The main feature of the invention is that the watch casing comprises thereon an outside facing light source which is coupled to a power supply device housed in the casing, through a push-button accessible on the outer surface of the casing.

### BACKGROUND OF THE INVENTION

The present invention relates to a wrist watch including an illuminating means or device.

Wrist watches including lighting means which can be actuated in order to facilitate the detection of the time indicated by the watch, especially during night hours or under poor illuminating conditions, are already known.

In these prior watches, the light source is exclusively designed for illuminating the watch dial.

The light which is outward projected does not allow an outward visibility.

A further problem affecting prior watches of the above mentioned type, is that the mentioned light sources have a comparatively high power drain and, accordingly, cause a quick exhaustion of the watch battery.

### SUMMARY OF THE INVENTION

Accordingly, the aim of the present invention is to provide a wrist watch, including illuminating means, providing the watch user with a light source which can be used for illuminating outside objects.

Within the scope of the above mentioned aim, a main object of the present invention is to provide such an illuminated wrist watch the illuminating means of which consume a comparatively small electric power.

Yet another object of the present invention is to provide such a wrist watch which, owing to its specifically designed construction, is very reliable and safe in operation.

Yet another object of the present invention is to provide such an illuminated wrist watch which can be easily made starting from easily available elements and materials and which, moreover, is very competitive from a-mere economic standpoint.

According to one aspect of the present invention, the above mentioned aim and objects, as well as yet other objects, which will become more apparent hereinafter, are achieved by a wrist watch, including lighting means, said wrist watch comprising a watch casing holding a watch controlling mechanism, and being characterized in that on said watch casing is provided an outward facing light source, said light source being coupled to a power supply unit housed in said watch casing, through a push-button arranged on an outer surface of said watch casing.

### BRIEF DESCRIPTION OF THE DRAWINGS

Further characteristics and advantages of the present invention will become more apparent hereinafter from the following detailed disclosure of a wrist watch, including lighting or illuminating means, and which is illustrated, by way of an indicative, but not limitative, example, in the accompanying drawings, where:

FIG. 1 is a schematic perspective view illustrating the wrist watch according to the present invention, during the use thereof;

FIG. 2 is a top plan view of the wrist watch according to the present invention; and

FIG. 3 is a further top plan view of the wrist watch according to the invention, in a use condition thereof.

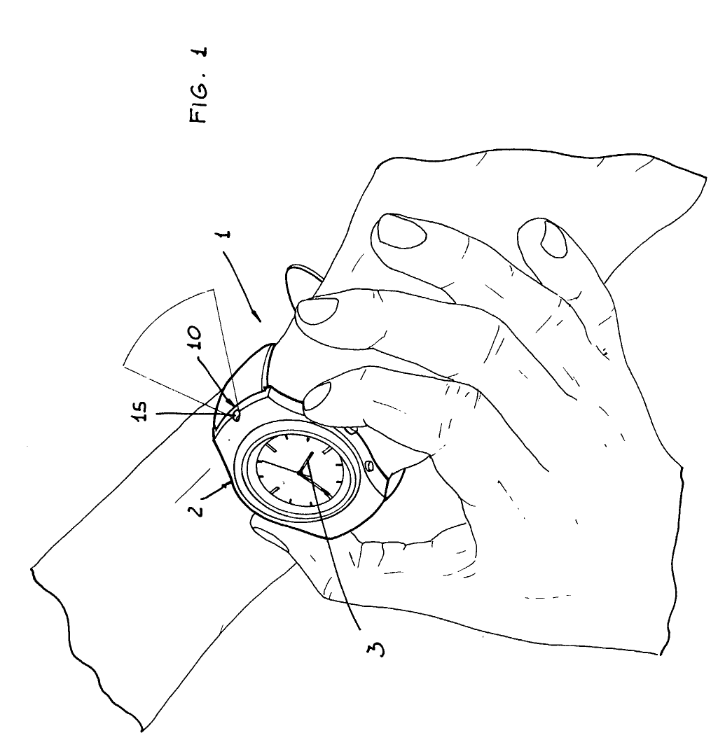

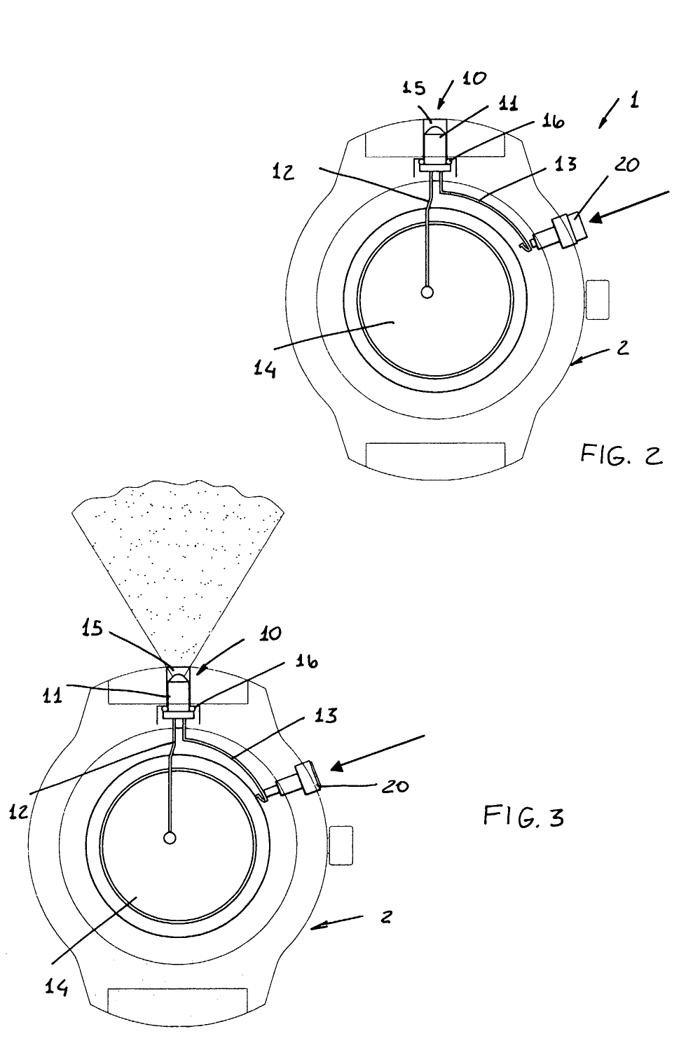

### DESCRIPTION OF THE PREFERRED EMBODIMENT

With reference to the number references of the above mentioned figures, the wrist watch including lighting means according to the present invention, which has been generally indicated by the reference number 1, comprises a wrist watch casing or case 2, in which is arranged a watch controlling mechanism, designed for controlling the watch pointers 3, as shown in the drawing, or a digital display means.

The main feature of the invention is that the watch further comprises, on the casing 2 thereof, a light source 10 which, advantageously, is arranged at the 12 o'clock position, and includes a white LED 11, the contacts 12 and 13 of which are respectively coupled to a battery or power supply 14, housed in the watch casing 2, and a push-button 20, arranged on the outside of the watch casing.

Thus, with the disclosed device, as the push-button 20 is actuated, the electric circuit supplying the LED 11 will be closed, and the LED will emit, through an opening 15 defined through the casing, a light beam having a comparatively high intensity, with a reduced power drain.

Advantageously, a sealing O-ring 16 encompasses the LED 11, to provide a good tightness and waterproof characteristic.

From the above disclosure, it should be apparent that the invention fully achieves the intended aim and objects.

In fact, the invention provides a wrist watch, including lighting means, allowing to emit a light beam, and design for providing a good environmental visibility, under all the lighting conditions.

In practicing the invention, the used materials, provided that they are compatible to the intended application, as well as the contingent size and shapes, can be any, depending on requirements.

1. A wrist watch, including lighting means, said wrist watch comprising a watch casing holding a watch controlling mechanism, and being characterized in that on said watch casing is provided an outward facing light source, said light source being coupled to a power supply unit housed in said watch casing, through a push-button arranged on an outer surface of said watch casing.

2. A wrist watch, according to claim 1, wherein said light source comprises a white LED.

3. A wrist watch, according to claim 2, wherein said LED is arranged in an opening of the watch casing, to provide an outward directed light beam.

4. A wrist watch, according to claim 2, wherein said LED is arranged at a 12 o'clock position.

5. A wrist watch, according to claim 2, wherein said LED is encompassed, at a bottom portion thereof, by a sealing O-ring.

6. A wrist watch, according to claim 2, wherein said LED comprises a contact coupled to a post of a battery and another contact coupled to said watch casing, through a push-button element.
